(19) United States
(12) Patent Application Publication
(10) Pub. No.: US 2025/0071537 A1
(43) Pub. Date: Feb. 27, 2025

(54) SERVER OPERATION METHOD FOR PREDICTING MOBILITY OF USER TERMINAL AND SERVER THEREFOR

(71) Applicants: Samsung Electronics Co., Ltd., Suwon-si (KR); RESEARCH & BUSINESS FOUNDATION SUNGKYUNKWAN UNIVERSITY, Suwon-si (KR); SK TELECOM CO., LTD., Seoul (KR)

(72) Inventors: Bokkeun KIM, Suwon-si (KR); Hyun Seung CHOO, Suwon-si (KR); Joong Gunn PARK, Seoul (KR); Hyun Jun CHOI, Seoul (KR); Dong Jin LEE, Seoul (KR)

(21) Appl. No.: 18/942,056

(22) Filed: Nov. 8, 2024

Related U.S. Application Data
(63) Continuation of application No. PCT/KR2023/006348, filed on May 10, 2023.

(30) Foreign Application Priority Data
May 10, 2022 (KR) 10-2022-0057361
Jul. 20, 2022 (KR) 10-2022-0089891

(51) Int. Cl. H04W 8/08; H04W 64/00

(52) U.S. Cl. CPC H04W 8/08; H04W 64/00

(57) ABSTRACT

A server according to an embodiment can collect mobility data of user terminals and group the user terminals into clusters based on the similarity the similarity of the mobility data. The server applies identification information of the clusters to which the grouped user terminals belong and previous movement paths of the grouped user terminals to a neural network-based prediction model, thus making it possible to train a prediction model to predict a base station serving moving locations of the user terminals belonging to each cluster.

### CROSS-REFERENCE TO RELATED APPLICATIONS

This application is a continuation of International Application No. PCT/KR2023/006348, designating the United States, filed on May 10, 2023, in the Korean Intellectual Property Receiving Office and claiming priority to Korean Patent Application Nos. 10-2022-0057361, filed on May 10, 2022, and 10-2022-0089891, filed on Jul. 20, 2022, in the Korean Intellectual Property Office, the disclosures of each of which are incorporated by reference herein in their entireties.

### BACKGROUND

### Field

The disclosure relates to an operating method of a server for predicting the mobility of a user terminal and the server.

### Description of Related Art

A base station in a mobile network may repeat the releasing and reconnecting of a wireless connection to reduce power consumption and save wireless resources. A base station of a 5G network, such as a next-generation node B (gNB), may predict the mobility of a user terminal and may perform various network functions, such as paging, handover, and/or edge computing, through the mobility of the predicted user terminal.

Machine learning models for predicting the mobility of a user terminal may predict the future position of the user terminal based on the previous movement path of the user terminal. When training a machine learning model using only previous movement paths to predict the position of the user terminal, prediction accuracy may be high for the mobility of the user terminal following a general movement pattern, but the prediction accuracy may be low for the mobility of the user terminal not following the general movement pattern.

In addition, to maintain the accuracy of the machine learning model, newly generated data may need to be learned continuously. When providing a prediction result to each user terminal using the machine learning model all the time, the consumption of computational resources may increase.

### SUMMARY

Embodiments of the disclosure provide a prediction model that may be trained in a machine learning method, based on the similarity of the mobility data including the previous movement patterns of user terminals, the day of the week, or time information.

Embodiments of the disclosure provide a prediction model that may be trained by applying the identification information of clusters including user terminals grouped based on the similarity of the mobility data and previous movement paths of the grouped user terminals to a neural network-based prediction model, to predict a base station for serving the movement positions of user terminals belonging to each cluster.

Embodiments of the disclosure may provide a service for the target terminal at a predicted movement position while determining a target cluster to include a target terminal, the mobility of which is to be predicted, and predicting the movement position of the target terminal by inputting the identification information of the target cluster and the previous movement path of the target terminal into a trained prediction model.

According to various embodiments, the accuracy of a predicted movement position of a user terminal by each cluster may be evaluated, and training may be performed on clusters having an accuracy lower than a certain reference value.

According to various embodiments, the mobility of a user terminal may be predicted using a trained prediction model, and various network functions, such as paging, handover, and/or edge computing, may be performed according to the predicted mobility.

According to an example embodiment, a method of operating a server includes: collecting mobility data of user terminals, grouping the user terminals into clusters based on the similarity of the mobility data, and training a prediction model to predict a base station for serving the movement positions of the user terminals belonging to the clusters by each cluster by applying the identification information of the clusters including grouped user terminals and previous movement paths of the grouped user terminals to the prediction model based on a neural network.

According to an example embodiment, a method of operating a server includes: receiving mobility data of a target terminal, determining a target cluster to include the target terminal, based on the mobility data, predicting the movement position of the target terminal by inputting the identification information of the target cluster and a previous movement path of the target terminal into a trained prediction model, and providing a service for the target terminal at a predicted movement position.

According to an example embodiment, a server includes: a communication interface comprising communication circuitry configured to receive the mobility data of user terminals and at least one processor, comprising processing circuitry, individually and/or collectively, configured to: group the user terminals into clusters based on the similarity of the mobility data and train a prediction model to predict a base station for serving the movement position of the user terminals belonging to each cluster by applying previous movement paths of grouped user terminals to the prediction model based on a neural network.

According to various example embodiments, a server may improve the accuracy of a prediction model for predicting the mobility of a user terminal by training the identification information of clusters, including user terminals clustered using mobility data, including the previous movement patterns of the user terminals, a day of the week, and time information, together with the mobility data.

According to various example embodiments, the server may reduce the computational cost and/or training time that is used to train the prediction model by predicting the mobility by each cluster, not an individual user terminal.

According to various example embodiments, the server may improve prediction accuracy for user terminals having peculiar movement patterns by predicting the mobility by each cluster, not an individual user terminal.

According to various example embodiments, the server may significantly reduce costs consumed for training by preferentially evaluating the accuracy of a predicted movement position of a user terminal by each cluster instead of training all data sets when training a prediction model, selecting clusters, the accuracy of which is lower than a certain reference value, and performing the training of the prediction model.

In addition, various effects directly or indirectly ascertained through the present disclosure may be provided.

### BRIEF DESCRIPTION OF DRAWINGS

The above and other aspects, features and advantages of certain embodiments of the present disclosure will be more apparent from the following detailed description, taken in conjunction with the accompanying drawings, in which:

FIG. 1 is a flowchart illustrating an example method of operating a server, according to various embodiments;

FIG. 2 is a diagram illustrating an example method of grouping user terminals into clusters, according to various embodiments;

FIG. 3 is a flowchart illustrating an example method of training a prediction model, according to various embodiments;

FIG. 4 is a diagram illustrating an example method of training a prediction model, according to various embodiments;

FIG. 5 is a diagram illustrating an example structure of a prediction model, according to various embodiments;

FIG. 6 is a flowchart illustrating an example method of operating a server, according to various embodiments;

FIG. 7 is a block diagram illustrating an example configuration of a server, according to various embodiments; and

FIG. 8 is a block diagram illustrating an example electronic device in a network environment, according to various embodiments.

### DETAILED DESCRIPTION

Hereinafter, various example embodiments are described in greater detail with reference to the accompanying drawings. When describing the various embodiments with reference to the accompanying drawings, like reference numerals refer to like elements and a repeated description related thereto is omitted.

The electronic device according to various embodiments disclosed herein may be one of various types of electronic devices. The electronic device may include, for example, a portable communication device (e.g., a smartphone), a computer device, a portable multimedia device, a portable medical device, a camera, a wearable device, a home appliance device, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, “A or B”, “at least one of A and B”, “at least one of A or B”, “A, B or C”, “at least one of A, B and C”, and “A, B, or C,” each of which may include any one of the items listed together in the corresponding one of the phrases, or all possible combinations thereof. Terms such as “first”, “second”, or “first” or “second” may simply be used to distinguish the component from other components in question and may refer to components in other aspects (e.g., importance or order) is not limited. It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., by wire), wirelessly, or via a third element.

As used in connection with embodiments of the disclosure, the term “module” may include a unit implemented in hardware, software, or firmware, or any combination thereof, and may interchangeably be used with other terms, for example, “logic”, “logic block”, “part”, or “circuitry”. A module may be a single integral component, or a minimum unit or part thereof, adapted to perform one or more functions. For example, according to an embodiment, the module may be implemented in a form of an application-specific integrated circuit (ASIC).

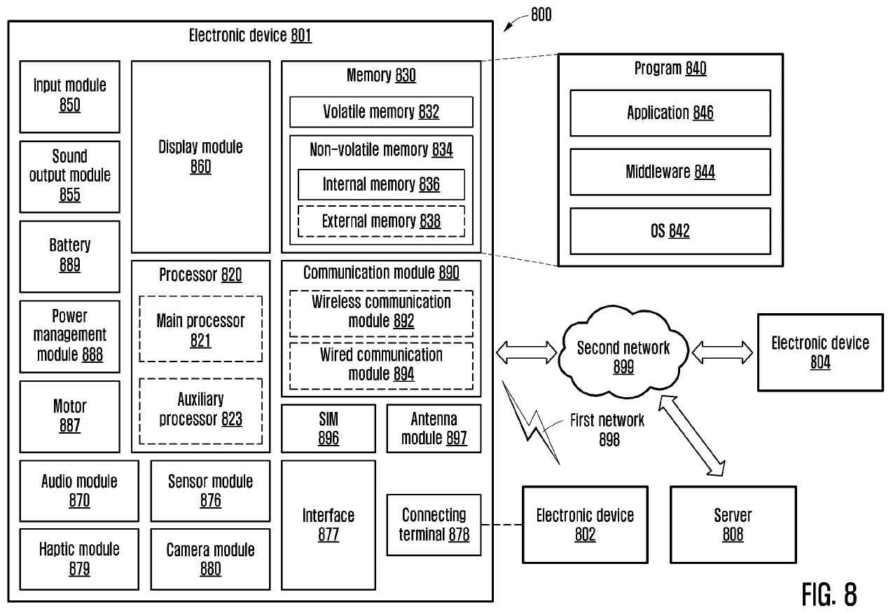

An embodiment as set forth herein may be implemented as software (e.g., a program 840) including one or more instructions that are stored in a storage medium (e.g., internal memory 836 or external memory 838) that is readable by a machine (e.g., an electronic device 801 of FIG. 8). For example, a processor (e.g., a processor 820) of the machine (e.g., the electronic device 801) may invoke at least one of the one or more instructions stored in the storage medium and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to embodiments of the disclosure may be included and provided in a computer program product. The computer program product may be traded as a product between a seller and a buyer. The computer program product may be distributed in the form of a machine-readable storage medium (e.g., a compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities, and some of the multiple entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to embodiments, the integrated component may still perform one or more functions of each of the plurality of components in the same or similar manner as they are performed by a corresponding one of the plurality of components before the integration. According to embodiments, operations performed by the module, the program, or another component may be carried out sequentially, in parallel, repeatedly, or heuristically, or one or more of the operations may be executed in a different order or omitted, or one or more other operations may be added.

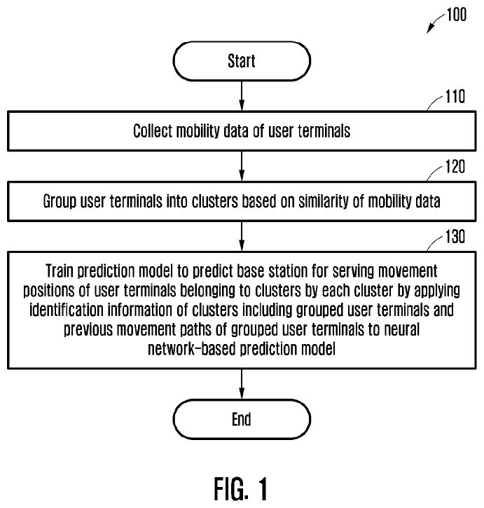

FIG. 1 is a flowchart illustrating an example method of operating a server, according to various embodiments. In the following embodiments, operations may be performed sequentially but may not be necessarily performed sequentially. For example, the order of the operations may be changed and at least two of the operations may be performed in parallel.

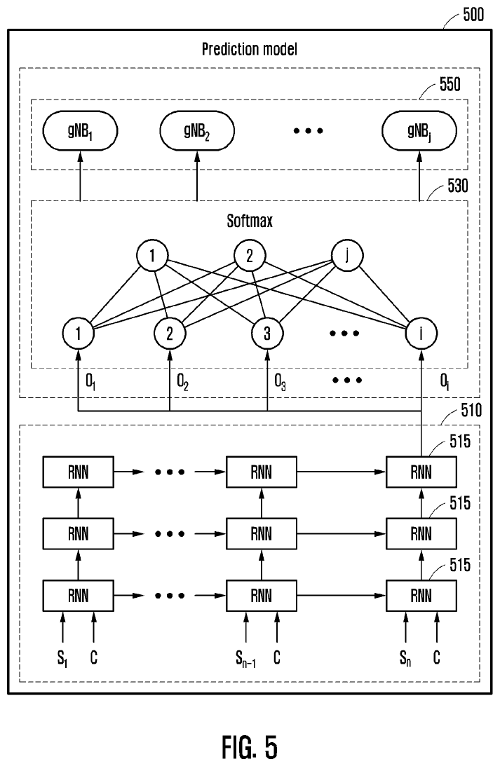

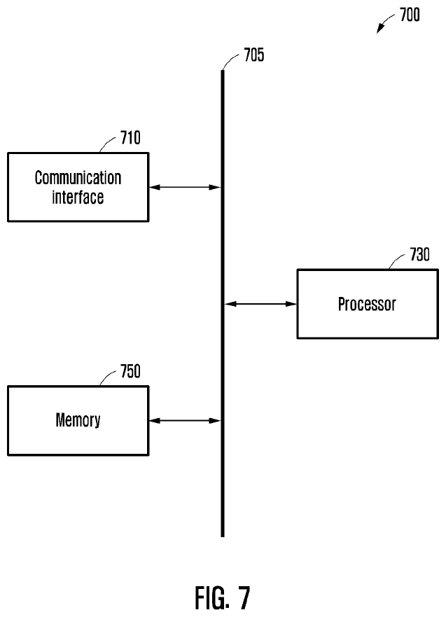

Referring to flowchart 100 of FIG. 1, according to an embodiment, the server (e.g., a server 700 of FIG. 7 and/or a server 808 of FIG. 8) may train a prediction model (e.g., a prediction model 500 of FIG. 5) through operations 110 to 130.

In operation 110, the server may collect the mobility data of user terminals (e.g., the electronic device 801 of FIG. 8). For example, the server may collect the mobility data by sampling a movement path of the user terminals at fixed time intervals, but examples are not limited thereto.

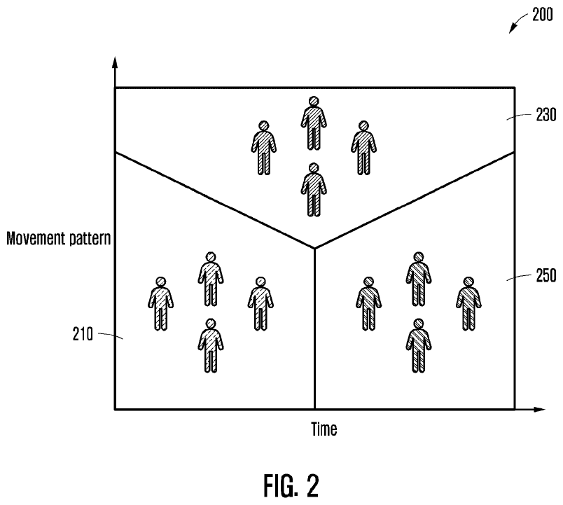

In operation 120, the server may group the user terminals into clusters (e.g., clusters 210, 230, and 250 of FIG. 2) based on the similarity of the mobility data collected in operation 110. For example, the server may group the user terminals into the clusters through the similarity between any one or a combination of a movement time and a movement pattern based on the mobility data. For example, the movement time may include any one or a combination of a time of day, a day of the week, a date, and a season, but examples are not limited thereto.

The grouping of the user terminals into the clusters may be referred to as ‘clustering’. The clustering may include one or more of various unsupervised learning techniques in machine learning and may be understood as the classifying of similar pieces of data in a data set into a group.

For example, the server may group the user terminals into the clusters using a machine learning-based clustering technique including a k-mean clustering technique, a k-nearest neighbor clustering technique, and a mean-shift clustering technique, but examples are not limited thereto. The server may use various clustering techniques and may group the user terminals depending on a movement pattern, a time of day, and a day of the week.

For example, when classifying a data set into k clusters, the data set may include k centroids. In this case, the k-mean clustering technique may refer to the assigning of pieces of data included in the data set to a close centroid based on a Euclidean distance and the grouping of pieces of data gathering at the same centroid into one cluster. The ‘mean’ in the k-mean clustering technique may refer to a mean distance between pieces of data and each cluster's centroid. The method of the server grouping user terminals into clusters is described in detail below with reference to FIG. 2.

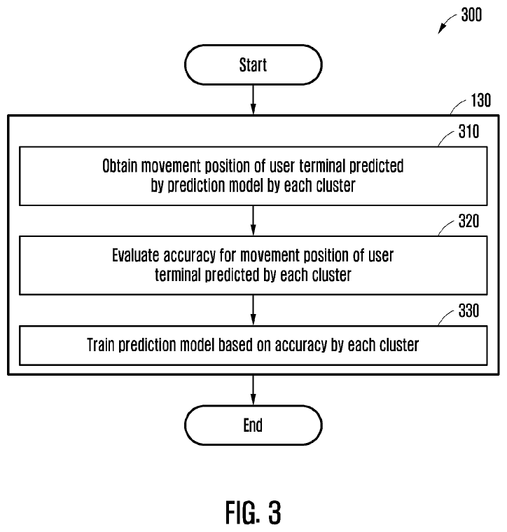

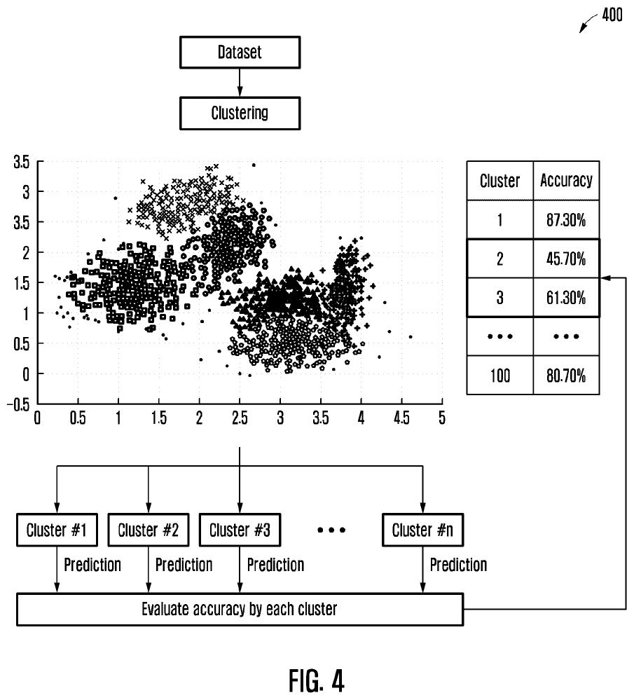

In operation 130, the server may train a prediction model to predict a base station for serving the movement positions of the user terminals belonging to the clusters by each cluster by applying the identification information of the clusters including the user terminals grouped in operation 120 and previous movement paths of the grouped user terminals to the prediction model based on a neural network. Hereinafter, the ‘training’ may be used interchangeably with the ‘learning’. A method of the server training a prediction model is described in greater detail below with reference to FIGS. 3 and 4. In addition, according to various embodiments, the structure and operations of the prediction model are described in greater detail below with reference to FIG. 5.

FIG. 2 is a diagram illustrating an example method of grouping user terminals into clusters, according to various embodiments. FIG. 2 includes diagram 200 illustrating a method of a server (e.g., the server 700 of FIG. 7 and/or the server 808 of FIG. 8), according to an embodiment, grouping the user terminals (e.g., the electronic device 801 of FIG. 8) into the clusters.

The server may classify the user terminals before training a prediction model, which is a machine learning model for predicting the mobility of a user terminal, using various clustering techniques, such as a k-mean clustering technique, a k-nearest neighbor clustering technique, and a mean-shift clustering technique.

The server may group the mobility data of the user terminals into multiple clusters 210, 230, and 250 according to similarity through various clustering techniques. For example, the server may group the user terminals into the clusters through the similarity between any one or a combination of a movement time and a movement pattern based on the mobility data. For example, the movement time may include any one or a combination of a time of day, a day of the week, a date, and a season, but examples are not limited thereto. For example, the movement pattern may include various movement routes other than movement inside the center of a city, movement at the outskirts of the city, and/or movement on a highway, but examples are not limited thereto.

For example, various Internet of things (IoT) terminals may be added to a 5G network, and the IoT terminals may have significantly diverse movement patterns. In addition, even the same user terminal may have different movement patterns depending on, e.g., whether it is weekdays from Monday to Friday or a weekend, such as Saturday or Sunday, and/or whether it is dawn, morning, afternoon, or night even during the same day of the week.

For example, the server may group user terminals with high mobility within the center of a city during weekdays into a first cluster 210, based on the mobility data of the user terminals. The server may group user terminals always having high mobility on the outskirts of the city in addition to the center of the city regardless of a day of the week into a second cluster 230. In addition, the server may group user terminals with high mobility within the center of the city during a weekend into a third cluster 250.

For example, the server may assign ‘l’ as identification information (ID) to the first cluster 210, may assign ‘2’ as ID to the second cluster 230, and may assign ‘3’ as ID to the third cluster 250, but examples are not limited thereto. In addition, the server may assign ID to the clusters in various ways, such as ‘A’, ‘B’, and ‘C’ or ‘1-1’ and ‘1-2’. The server may assign the ID of clusters, including user terminals, to the user terminals grouped in each of the clusters.

FIG. 3 is a flowchart illustrating an example method of training a prediction model, according to various embodiments. In the following embodiments, operations may be performed sequentially but may not be necessarily performed sequentially. For example, the order of the operations may be changed and at least two of the operations may be performed in parallel.

Referring to flowchart 300 of FIG. 3, according to an embodiment, the server (e.g., the server 700 of FIG. 7 and/or the server 808 of FIG. 8) may train a prediction model (e.g., the prediction model 500 of FIG. 5) through operations 310 to 330.

In operation 310, the server may obtain the movement position of a user terminal (e.g., the electronic device 801 of FIG. 8) predicted by the prediction model, e.g., by each cluster.

In operation 320, the server may evaluate accuracy for the movement position of the user terminal (e.g., the electronic device 801 of FIG. 8) predicted by each cluster (e.g., the clusters 210, 230, and 250 of FIG. 2) in operation 310. The server may evaluate the accuracy based on whether the movement position of the user terminal predicted by each cluster corresponds to an area that is served by a predicted base station. For example, when a movement position a of the user terminal predicted by each cluster corresponds to an area A served by the predicted base station, the server may evaluate the accuracy as ‘high’ among high, medium, and low or may evaluate the accuracy as 95% or 99%. On the other hand, when a movement position b of the user terminal predicted by each cluster does not correspond to the area A served by the predicted base station, the server may evaluate the accuracy as ‘medium’ or ‘low’ or as ‘60%’ or ‘45%’ according to a distance difference or a distance proportion between the movement position b of the user terminal and the area A served by the predicted base station.

In operation 330, the server may train the prediction model based on the accuracy by each cluster evaluated in operation 320. The server may determine a target cluster to be used to train the prediction model among the clusters using the accuracy of each cluster. For example, the server may determine a cluster as the target cluster when the accuracy of the cluster is lower than a preset reference value among the clusters. For example, the server may not determine a cluster as the target cluster when the accuracy of the cluster is greater than or equal to the preset reference value among the clusters. In this case, the number of determined target clusters may be one or plural depending on the accuracy. The server may train the prediction model by applying the identification information of the target cluster and movement paths of user terminals belonging to the target cluster to the prediction model.

In an embodiment, the training of the prediction model by each of the clusters grouped in various movement patterns described above may improve the accuracy of the prediction model for a corner case.

FIG. 4 is a diagram illustrating an example method of training a prediction model, according to various embodiments. FIG. 4 includes diagram 400 illustrating the method of a server (e.g., the server 700 of FIG. 7 and/or the server 808 of FIG. 8), according to an embodiment, training the prediction model (e.g., the prediction model 500 of FIG. 5) according to the accuracy of the movement position of a user terminal (e.g., the electronic device 801 of FIG. 8) predicted by each cluster (e.g., the clusters 210, 230, and 250 of FIG. 2).

According to an embodiment, the server may continue to periodically learn a path recently traveled by the user terminal and may update the prediction model to maintain accuracy greater than or equal to a certain level in the mobility prediction of the user terminal.

The server may perform clustering on a data set including the mobility data of user terminals. The server may group the user terminals into the clusters based on the similarity of the mobility data. In an embodiment, the prediction accuracy of the prediction model may be improved by performing clustering in a machine learning method using the previous movement pattern of a user terminal, a day of the week, and/or time information and training the identification information of a cluster when training the prediction model.

The server may predict the movement position of a user terminal by each grouped cluster (e.g., a first cluster (cluster #1), a second cluster (cluster #2), a third cluster (cluster #3), . . . , and an nth cluster (cluster #n)). The server may evaluate the accuracy of the movement position of the user terminal predicted by each cluster. For example, the server may evaluate the accuracy based on whether the movement position of the user terminal predicted by each cluster corresponds to an area that is served by a base station predicted by the prediction model. When the user terminal is in the area served by the base station, the server may evaluate the accuracy as high. The server may reduce the computational cost and/or training time that is used to train the prediction model by transmitting a prediction result by each cluster, not an individual user terminal.

For example, based on the evaluated accuracy, the server may reduce an overall learning amount of the prediction model by not learning a cluster having an accuracy higher than a preset reference value and learning a cluster having an accuracy less than or equal to the preset reference value.

For example, the accuracy of the first cluster predicted by the prediction model may be 98.3%, the accuracy of the second cluster may be 45.7%, the accuracy of the third cluster may be 63.1%, and the accuracy of a hundredth cluster may be 80.70%. Here, the preset reference value for accuracy may be, e.g., 70%.

The server may train the prediction model through mobility data belonging to the second cluster and the third cluster having the accuracy less than the preset reference value by comparing the accuracy of each cluster predicted by the prediction model with the preset reference value (e.g., 70%).

In an embodiment, data sets classified into the same cluster may have mobility data with similar patterns. Thus, the accuracy of the prediction model may be maintained only by learning some of the data sets in the cluster. In addition, although the predicting of the movement position of the user terminal by each cluster is performed before the training of the prediction model, this predicting does not include the backpropagation of the prediction model. Thus, a processing time and a computational amount may not be consumed significantly for the predicting.

In an embodiment, a training amount and/or a cost required for training may be reduced significantly and the prediction accuracy of the prediction model may be maintained by pre-testing the prediction accuracy of each cluster and selecting and training clusters having low accuracy instead of training mobility data included in all the data sets when training the prediction model.

FIG. 5 is a diagram illustrating an example structure of a prediction model, according to various embodiments. FIG. 5 illustrates an example configuration of the prediction model 500, according to various embodiments.

For example, the prediction model 500 may be a machine learning model or a deep neural network (DNN)-based model.

For example, the prediction model 500 may include a layered DNN 510 and fully connected layers 530.

For example, DNN cells 515 included in the layered DNN 510 may refer to a recurrent neural network (RNN)-type AI model, but examples are not limited thereto. The DNN cells 515 may refer to a recurrent layer of a DNN, and an output result of cells may be referred to as a ‘hidden state’. For example, the DNN cells 515 may be RNN cells, but examples are not limited thereto.

The layered DNN 510 may learn a spatiotemporal feature for the mobility of a user terminal (e.g., the electronic device 801 of FIG. 8) by receiving identification information C of clusters (e.g., the clusters 210, 230, and 250 of FIG. 2) and previous position paths Sn of grouped user terminals. For example, the layered DNN 510 may be an RNN-type neural network, such as a long short-term memory (LSTM) or a gated recurrent unit (GRU), but examples are not limited thereto. In this case, the identification information C of the clusters may be determined by a server before the machine learning of the prediction model 500.

The layered DNN 510 may include an input layer including the DNN cells 515 and hidden layers. As the identification information C of the clusters and previous movement paths S of the grouped user terminals are applied to the input layer of the layered DNN 510, the hidden layers learn a movement position, to which the user terminal is predicted to move, based on the previous movement paths S.

For example, the layered DNN 510 may include three layers of the RNN cells 515, but examples are not limited thereto. Although FIG. 5 illustrates a layered structure having three layers for ease of description, examples are not limited thereto. The prediction model 500 may be a multilayer neural network having a depth greater than the three layers.

A first layer of the layered DNN 510 may be an input layer to receive the identification information C of the clusters and the previous movement paths of the grouped user terminals. The previous position paths Sn [symbol] S₁, . . . , Sₙ₋₁, Sₙ [symbol] of the user terminals input respectively to the DNN cells 515 in the input layer may be previous position information at fixed time intervals and, e.g., may be input sequentially at a length of an input sequence from S₁ to Sn. In addition, the identification information C of the clusters input to the input layer is not time-series data and, thus, may be input equally to the DNN cells 515 and may be learned regardless of an input order or position. In an embodiment, while providing differentiated learning and prediction by each cluster despite using one prediction model using the identification information C of the clusters as an input of the prediction model 500, the performance of the prediction model may be improved.

A second layer and a third layer of the layered DNN 510 may operate as hidden layers that are not engaged in an input and an output. In this case, a value suitable for an application environment may be set experimentally and/or empirically for the number of layers and the number of nodes used as the hidden layers in the layered DNN 510.

An output of the DNN cells 515 is transmitted to the neighboring, next DNN cell of the same layer and DNN cells of the next layer, and, thus, an output of the final DNN cell of the top layer may be a final output O of the layered DNN 510.

For example, the fully connected layers 530 may output a base station list 550 including a probability that a user terminal is at each base station gNB from the final output O of the layered DNN 510 through an activation function, such as a Softmax activation function. In an embodiment, the Softmax activation function is provided as an example for ease of description, but examples are not limited thereto. Various activation functions may be used other than the Softmax activation function.

The fully connected layers 530 may output j hidden state values as many as the number of base stations to be predicted by receiving i final outputs O of the layered DNN 510. Here, i may be the same as or different from n, which is the number of input values of the layered DNN 510. For example, the Softmax activation function may output a normalized value between 0 to 1, and the sum of output values may always be 1. Accordingly, each of the output values of the prediction model 500 may be the probability that the user terminal is in a corresponding base station.

The server (e.g., the server 700 of FIG. 7 and/or the server 808 of FIG. 8) may align the probability that the user terminal is at each base station, which is output through the fully connected layers 530, and may output the base station list 550 including base stations corresponding to a probability as a certain percentage (e.g., a top 20%) among aligned probabilities. In this case, the base stations included in the base station list 550 may be base stations for serving a position or an area to which the user terminal is predicted to move.

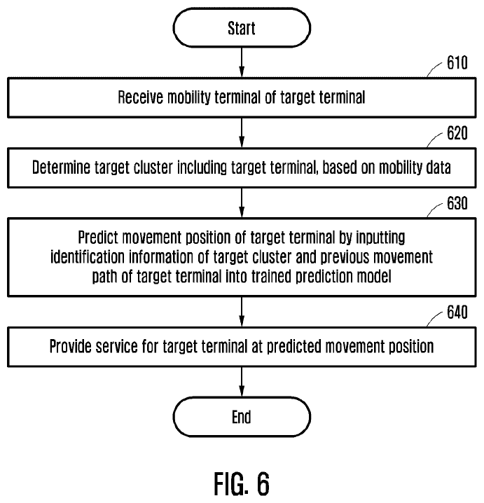

FIG. 6 is a flowchart illustrating an example method of operating a server, according to various embodiments. In the following embodiments, operations may be performed sequentially but may not be necessarily performed sequentially. For example, the order of the operations may be changed and at least two of the operations may be performed in parallel.

Referring to flowchart 600 of FIG. 6, the server (e.g., the server 700 of FIG. 7 and/or the server 808 of FIG. 8), according to an embodiment, may predict the mobility of a target terminal (e.g., the electronic device 801 of FIG. 8) through operations 610 to 640 and may provide a service for the target terminal at a predicted movement position.

In operation 610, the server may receive the mobility terminal of the target terminal. For example, mobility data may include position information including a movement path traveled by a user terminal and/or time information, but examples are not limited thereto. The position information may include any one or a combination of the identification information (e.g., the ID of the user terminal) of the user terminal, information on a first base station corresponding to a first position (e.g., a source) from which the user terminal departs in an activation mode, and information on a second base station corresponding to a second position (e.g., a destination) at which the user terminal arrives, moving from the first position, in the activation mode, but examples are not limited thereto.

In operation 620, the server may determine a target cluster to include the target terminal, based on the mobility data received in operation 610. The server may determine the target cluster to include the target terminal by comparing a result of analyzing any one or a combination of a movement time and a movement pattern based on the mobility data with a preset cluster type.

In operation 630, the server may predict the movement position of the target terminal by inputting the identification information of the target cluster determined in operation 620 and the previous movement path of the target terminal into a trained prediction model (e.g., the prediction model 500 of FIG. 5). The prediction model may include a neural network-based prediction model that is trained to predict base stations for serving a position to which the target terminal is predicted to move through previous movement paths of user terminals belonging to each cluster and type information of clusters.

In operation 640, the server may provide a service for the target terminal at a predicted movement position. For example, the service for the target terminal may include the re-selection of a user plane function (UPF) of paging, handover, and/or edge computing, but examples are not limited thereto.

FIG. 7 is a block diagram illustrating an example configuration of a server, according to various embodiments. Referring to FIG. 7, the server 700 (e.g., the server 808 of FIG. 8), according to an embodiment, may include a communication interface (e.g., including communication circuitry) 710, a processor (e.g., including processing circuitry) 730, and a memory 750.

The communication interface 710, the processor 730, and the memory 750 may be connected to one another through a communication bus 705.

The communication interface 710 may receive the mobility data of user terminals (e.g., the electronic device 801 of FIG. 8).

The processor 730 may include various processing circuitry and group the user terminals into clusters based on the similarity of the mobility data received through the communication interface 710. The processor 730 may train a prediction model to predict a base station for serving the movement positions of the user terminals belonging to the clusters (e.g., the clusters 210, 230, and 250 of FIG. 2) by each cluster by applying the identification information of the clusters including grouped user terminals and the previous movement paths of the grouped user terminals to a prediction model (e.g., the prediction model 500 of FIG. 5) based on a neural network.

The processor 730 may obtain the movement position of a user terminal predicted by the prediction model by each cluster. The processor 730 may evaluate the accuracy of the movement position of the user terminal predicted by each cluster. The processor 720 may train the prediction model based on the accuracy of each cluster.

The processor 730 may evaluate the accuracy based on whether the movement position of the user terminal predicted by each cluster corresponds to an area that is served by a predicted base station. The processor 730 may determine a target cluster to be used to train the prediction model among the clusters using the accuracy of each cluster. The processor 730 may train the prediction model by applying the identification information of the target cluster and movement paths of user terminals belonging to the target cluster to the prediction model.

According to an embodiment, based on the mobility data, the processor 730 may determine the target cluster to include a target terminal and may predict the movement position of the target terminal by inputting the identification information of the target cluster and the previous movement path of the target terminal into a trained prediction model. The processor 730 may provide a service for the target terminal at a predicted movement position.

The memory 750 may store the prediction model trained by the processor 730.

In addition, the processor 730 may execute a program and may control the server 700. The code of the program executed by the processor 730 may be stored in the memory 750.

The memory 750 may store information received from the communication interface 710. The memory 750 may store executable instructions to be executed by the processor 730. In addition, the memory 750 may store various pieces of information generated during the processing of the processor 730. In addition, the memory 750 may store various types of data and programs. The memory 750 may include a volatile memory or a non-volatile memory. The memory 750 may include a massive storage medium, such as a hard disk, and may store the various pieces of data.

In addition, the processor 730 may perform at least one method described above with reference to FIGS. 1 to 6 or a scheme corresponding to the at least one method. The processor 730 may be a hardware-implemented device or server having a circuit that is physically structured to execute desired operations. For example, the desired operations may include code or instructions in a program. The hardware-implemented server 700 may include, for example, a microprocessor, a central processing unit (CPU), a graphics processing unit (GPU), a processor core, a multi-core processor, a multiprocessor, an application-specific integrated circuit (ASIC), a field-programmable gate array (FPGA), and/or a neural processing unit (NPU). The processor 730 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

FIG. 8 is a block diagram illustrating an example electronic device in a network environment, according to various embodiments. Referring to FIG. 8, the electronic device 801 in a network environment 800 corresponding to an example of a user terminal, according to an embodiment, may communicate with an electronic device 802 via a first network 898 (e.g., a short-range wireless communication network), or may communicate with at least one of an electronic device 804 or the server 808 via a second network 899 (e.g., a long-range wireless communication network). According to an embodiment, the electronic device 801 may communicate with the electronic device 804 via the server 808. According to an embodiment, the electronic device 801 may include the processor 820, a memory 830, an input module 850, a sound output module 855, a display module 860, an audio module 870, a sensor module 876, an interface 877, a connecting terminal 878, a haptic module 879, a camera module 880, a power management module 888, a battery 889, a communication module 890, a subscriber identification module (SIM) 896, or an antenna module 897. In various embodiments, at least one of the components (e.g., the connecting terminal 878) may be omitted from the electronic device 801, or one or more other components may be added to the electronic device 801. In various embodiments, some of the components (e.g., the sensor module 876, the camera module 880, or the antenna module 897) may be integrated as a single component (e.g., the display module 860).

The processor 820 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 820 may execute, for example, software (e.g., a program 840 to control at least one other component (e.g., a hardware or software component) of the electronic device 801 coupled with the processor 820, and may perform various data processing or computation. According to an embodiment, as at least a part of data processing or computation, the processor 820 may store a command or data received from another component (e.g., the sensor module 876 or the communication module 890) in a volatile memory 832, process the command or the data stored in the volatile memory 832, and store resulting data in a non-volatile memory 834. According to an embodiment, the processor 820 may include the main processor 821 (e.g., a CPU or an application processor (AP)), or an auxiliary processor 823 (e.g., a GPU, an NPU, an image signal processor (ISP), a sensor hub processor, or a communication processor (CP)) that is operable independently from, or in conjunction with the main processor 821. For example, when the electronic device 801 includes the main processor 821 and the auxiliary processor 823, the auxiliary processor 823 may be adapted to consume less power than the main processor 821 or to be specific to a specified function. The auxiliary processor 823 may be implemented separately from the main processor 821 or as a part of the main processor 821.

The auxiliary processor 823 may control at least some of functions or states related to at least one (e.g., the display module 860, the sensor module 876, or the communication module 890 of the components of the electronic device 801, instead of the main processor 821 while the main processor 821 is in an inactive (e.g., sleep) state, or together with the main processor 821 while the main processor 821 is an active state (e.g., executing an application). According to an embodiment, the auxiliary processor 823 (e.g., an ISP or a CP) may be implemented as a portion of another component (e.g., the camera module 880 or the communication module 890) that is functionally related to the auxiliary processor 823. According to an embodiment, the auxiliary processor 823 (e.g., an NPU) may include a hardware structure specified for processing of an artificial intelligence (AI) model. An artificial intelligence (AI) model may be generated by machine learning. Such learning may be performed by, for example, the electronic device 801 in which AI is performed or performed via a separate server (e.g., the server 808). Learning algorithms may include, but are not limited to, for example, supervised learning, unsupervised learning, semi-supervised learning, or reinforcement learning. The AI model may include a plurality of artificial neural network layers. An artificial neural network may include, for example, a DNN, a convolutional neural network (CNN), a RNN, a restricted Boltzmann machine (RBM), a deep belief network (DBN), a bidirectional recurrent DNN (BRDNN), a deep Q-network, or a combination of two or more thereof, but is not limited thereto. The AI model may additionally or alternatively include a software structure other than the hardware structure.

The memory 830 may store various pieces of data used by at least one component (e.g., the processor 820 or the sensor module 876) of the electronic device 801. The various pieces of data may include, for example, software (e.g., the program 840) and input data or output data for a command related thereto. The memory 830 may include the volatile memory 832 or the non-volatile memory 834.

The program 840 may be stored as software in the memory 830, and may include, for example, an operating system (OS) 842, middleware 844, or an application 846.

The input module 850 may receive a command or data to be used by another component (e.g., the processor 820) of the electronic device 801, from the outside (e.g., a user) of the electronic device 801. The input module 850 may include, for example, a microphone, a mouse, a keyboard, a key (e.g., a button), or a digital pen (e.g., a stylus pen).

The sound output module 855 may output a sound signal to the outside of the electronic device 801. The sound output module 855 may include, for example, a speaker or a receiver. The speaker may be used for general purposes, such as playing multimedia or playing record. The receiver may be used to receive an incoming call. According to an embodiment, the receiver may be implemented separately from the speaker or as a part of the speaker.

The display module 860 may visually provide information to the outside (e.g., a user) of the electronic device 801. The display module 860 may include, for example, a display, a hologram device, or a projector and control circuitry to control a corresponding one of the display, hologram device, and projector. According to an embodiment, the display module 860 may include a touch sensor adapted to detect a touch, or a pressure sensor adapted to measure the intensity of force incurred by the touch.

The audio module 870 may convert a sound into an electrical signal and vice versa. According to an embodiment, the audio module 870 may obtain the sound via the input module 850 or output the sound via the sound output module 855 or an external electronic device (e.g., the electronic device 802 such as a speaker or a headphone) directly or wirelessly connected with the electronic device 801.

The sensor module 876 may detect an operational state (e.g., power or temperature) of the electronic device 801 or an environmental state (e.g., a state of a user) external to the electronic device 801, and then generate an electrical signal or data value corresponding to the detected state. According to an embodiment, the sensor module 876 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 877 may support one or more specified protocols to be used for the electronic device 801 to be coupled with the external electronic device (e.g., the electronic device 802) directly (e.g., by wire) or wirelessly. According to an embodiment, the interface 877 may include, for example, a high-definition multimedia interface (HDMI), a universal serial bus (USB) interface, a secure digital (SD) card interface, or an audio interface.

The connecting terminal 878 may include a connector via which the electronic device 801 may be physically connected with the external electronic device (e.g., the electronic device 802. According to an embodiment, the connecting terminal 878 may include, for example, an HDMI connector, a USB connector, an SD card connector, or an audio connector (e.g., a headphone connector).

The haptic module 879 may convert an electrical signal into a mechanical stimulus (e.g., a vibration or a movement) or an electrical stimulus which may be recognized by a user via his or her tactile sensation or kinesthetic sensation. According to an embodiment, the haptic module 879 may include, for example, a motor, a piezoelectric element, or an electric stimulator.

The camera module 880 may capture a still image and moving images. According to an embodiment, the camera module 880 may include one or more lenses, image sensors, ISPs, or flashes.

The power management module 888 may manage power supplied to the electronic device 801. According to an embodiment, the power management module 888 may be implemented as, for example, at least a part of a power management integrated circuit (PMIC).

The battery 889 may supply power to at least one component of the electronic device 801. According to an embodiment, the battery 889 may include, for example, a primary cell which is not rechargeable, a secondary cell which is rechargeable, or a fuel cell.

The communication module 890 may support establishing a direct (e.g., wired) communication channel or a wireless communication channel between the electronic device 801 and the external electronic device (e.g., the electronic device 802, the electronic device 804, or the server 808 and performing communication via the established communication channel. The communication module 890 may include one or more communication processors that operate independently of the processor 820 (e.g., an AP) and support direct (e.g., wired) communication or wireless communication. According to an embodiment, the communication module 890 may include a wireless communication module 892 (e.g., a cellular communication module, a short-range wireless communication module, or a global navigation satellite system (GNSS) communication module) or a wired communication module 894 (e.g., a local area network (LAN) communication module, or a power line communication (PLC) module). A corresponding one of these communication modules may communicate with the external electronic device 804 via the first network 898 (e.g., a short-range communication network, such as Bluetooth™, wireless-fidelity (Wi-Fi) direct, or infrared data association (IrDA)) or the second network 899 (e.g., a long-range communication network, such as a legacy cellular network, a 5G network, a next-generation communication network, the Internet, or a computer network (e.g., a LAN or a wide area network (WAN)). These various types of communication modules may be implemented as a single component (e.g., a single chip) or may be implemented as multiple components (e.g., multiple chips) separate from each other. The wireless communication module 892 may identify and authenticate the electronic device 801 in a communication network, such as the first network 898 or the second network 899, using subscriber information (e.g., international mobile subscriber identity (IMSI)) stored in the SIM 896.

The wireless communication module 892 may support a 5G network after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 892 may support a high-frequency band (e.g., a mmWave band) to achieve, e.g., a high data transmission rate. The wireless communication module 892 may support various technologies for securing performance on a high-frequency band, such as, e.g., beamforming, massive multiple-input and multiple-output (massive MIMO), full dimensional MIMO (FD-MIMO), an array antenna, analog beamforming, or a large-scale antenna. The wireless communication module 892 may support various requirements specified in the electronic device 801, the external electronic device (e.g., the electronic device 804), or a network system (e.g., the second network 899). According to an embodiment, the wireless communication module 892 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 897 may transmit or receive a signal or power to or from the outside (e.g., the external electronic device) of the electronic device 801. According to an embodiment, the antenna module 897 may include an antenna including a radiating element including a conductive material or a conductive pattern formed in or on a substrate (e.g., a printed circuit board (PCB)). According to an embodiment, the antenna module 897 may include a plurality of antennas (e.g., array antennas). In such a case, at least one antenna appropriate for a communication scheme used in a communication network, such as the first network 898 or the second network 899, may be selected by, for example, the communication module 890 from the plurality of antennas. The signal or the power may be transmitted or received between the communication module 890 and the external electronic device via the at least one selected antenna. According to an embodiment, another component (e.g., a radio frequency integrated circuit (RFIC)) other than the radiating element may be additionally formed as part of the antenna module 897.

According to various embodiments, the antenna module 897 may form a mmWave antenna module. According to an embodiment, the mm Wave antenna module may include a PCB, an RFIC on a first surface (e.g., the bottom surface) of the PCB, or adjacent to the first surface of the PCB and capable of supporting a designated high-frequency band (e.g., a mm Wave band), and a plurality of antennas (e.g., array antennas) arranged on a second surface (e.g., the top or a side surface) of the PCB, or adjacent to the second surface of the PCB and capable of transmitting or receiving signals of the designated high-frequency band.

At least some of the above-described components may be coupled mutually and exchange signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 801 and the external electronic device 804 via the server 808 coupled with the second network 899. Each of the external electronic devices 802 and 804 may be a device of the same type as, or a different type from, the electronic device 801. According to an embodiment, all or some of operations to be executed by the electronic device 801 may be executed at one or more external electronic devices (e.g., the external devices 802 and 804, and the server 808). For example, if the electronic device 801 should perform a function or a service automatically, or in response to a request from a user or another device, the electronic device 801, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and may transfer an outcome of the performing to the electronic device 801. The electronic device 801 may provide the outcome, with or without further processing of the outcome, as at least part of a reply to the request. To that end, cloud computing, distributed computing, mobile edge computing (MEC), or client-server computing technology may be used, for example. The electronic device 801 may provide ultra-low-latency services using, e.g., distributed computing or MEC. In an embodiment, the external electronic device 804 may include an IoT device. The server 808 may be an intelligent server using machine learning and/or a neural network. According to an embodiment, the external electronic device 804 or the server 808 may be included in the second network 899. The electronic device 801 may be applied to intelligent services (e.g., smart home, smart city, smart car, or healthcare) based on 5G communication technology or IoT-related technology.

According to an example embodiment, a method of operating the server includes: collecting mobility data of the user terminals, grouping user terminals into clusters based on similarity of the mobility data, and training a prediction model to predict a base station for serving the movement positions of the user terminals belonging to the clusters by each cluster by applying the identification information of the clusters including grouped user terminals and previous movement paths of the grouped user terminals to the prediction model based on a neural network.

According to an example embodiment, the training of the prediction model may include: obtaining a movement position of the user terminal predicted by the prediction model by each cluster, evaluating accuracy for the movement position of the user terminal predicted by each cluster, and training the prediction model based on the accuracy of each cluster.

According to an example embodiment, the evaluating of the accuracy may include evaluating the accuracy based on whether the movement position of the user terminal predicted by each cluster corresponds to an area served by a predicted base station.

According to an example embodiment, the training of the prediction model based on the accuracy of each cluster may include: determining a target cluster to be used to train the prediction model among the clusters using the accuracy of each cluster and training the prediction model by applying the identification information of the target cluster and the movement paths of the user terminals belonging to the target cluster to the prediction model.

According to an example embodiment, the determining of the target cluster may include determining a cluster as the target cluster when the accuracy of the cluster is lower than a specified reference value among the clusters.

According to an example embodiment, the training of the prediction model may include training the prediction model to predict base stations for serving the movement paths of the user terminals belonging to the target cluster.

According to an example embodiment, the prediction model may include layered DNNs configured to train a spatiotemporal feature for the mobility of the user terminal by receiving the identification information of the clusters and the previous movement paths of the grouped user terminals and the fully connected layers configured to output the base station list including a probability that the user terminal is at each base station from an output of the layered DNNs.

According to an example embodiment, the layered DNN may include an input layer including DNN cells and hidden layers, in which, as the identification information of the clusters and the previous movement paths of the grouped user terminals are applied to the input layer, the hidden layers learn a movement position, to which the user terminal is predicted to move, based on the previous movement paths.

According to an example embodiment, the server may be configured to align the probability that the user terminal is at each base station, output through the fully connected layers, and may output the base station list including base stations corresponding to a probability as a certain percentage among aligned probabilities.

According to an example embodiment, the grouping may include grouping the user terminals into the clusters through similarity between any one or a combination of a movement time and a movement pattern based on the mobility data.

According to an example embodiment, the movement time may include any one or a combination of a time of day, a day of the week, a date, and a season.

According to an example embodiment, the grouping may include grouping the user terminals into the clusters using a machine learning-based clustering technique including a k-mean clustering technique, a k-nearest neighbor clustering technique, and a mean-shift clustering technique.

According to an example embodiment, the collecting of the mobility data may include collecting the mobility data by sampling the movement paths of the user terminals at fixed time intervals.

According to an example embodiment, a method of operating the server includes: receiving mobility data of a target terminal, determining a target cluster to include the target terminal, based on mobility data, predicting a movement position of the target terminal by inputting the identification information of the target cluster and a previous movement path of the target terminal into a trained prediction model, and providing a service for the target terminal at a predicted movement position.

According to an example embodiment, the determining of the target cluster may include determining the target cluster to include the target terminal by comparing a result of analyzing any one or a combination of a movement time and a movement pattern based on the mobility data with a preset cluster type.

According to an example embodiment, the prediction model may include a neural network-based prediction model trained to predict base stations for serving a position to which the target terminal is predicted to move through the previous movement paths of the user terminals belonging to each cluster and type information of clusters.

According to an example embodiment, a server includes: a \communication interface, comprising communication circuitry, configured to receive the mobility data of user terminals and at least one processor, comprising processing circuitry, individually and/or collectively configured to: group user terminals into clusters based on a similarity of mobility data and train a prediction model to predict a base station for serving movement position of the user terminals belonging to each cluster by applying previous movement paths of the grouped user terminals to the prediction model based on a neural network.

According to an example embodiment, at least one processor, individually and/or collectively, may be configured to: obtain the movement position of the user terminal predicted by the prediction model by each cluster, evaluate the accuracy for the movement position of the user terminal predicted by each cluster, and train the prediction model based on the accuracy of each cluster.

According to an example embodiment, at least one processor, individually and/or collectively, may be configured to: evaluate the accuracy based on whether the movement position of the user terminal predicted by each cluster corresponds to an area served by the predicted base station, determine a target cluster to be used to train the prediction model among the clusters using the accuracy of each cluster, and train the prediction model by applying the identification information of the target cluster and the movement paths of the user terminals belonging to the target cluster to the prediction model.

While the disclosure has been illustrated and described with reference to various example embodiments, it will be understood that the various example embodiments are intended to be illustrative, not limiting. It will also be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method of operating a server, the method comprising:
collecting mobility data of user terminals;
grouping the user terminals into clusters based on a similarity of the mobility data; and
training a prediction model to predict a base station for serving movement positions of the user terminals belonging to the clusters by each cluster by applying identification information of the clusters, comprising grouped user terminals, and previous movement paths of the grouped user terminals to the prediction model based on a neural network.

2. The method of claim 1, wherein
the training the prediction model comprises:
obtaining a movement position of a user terminal predicted by the prediction model by each cluster;
evaluating accuracy of the movement position of the user terminal predicted by each cluster; and
training the prediction model based on the accuracy of each cluster.

3. The method of claim 2, wherein
the evaluating the accuracy comprises:
evaluating the accuracy based on whether the movement position of the user terminal predicted by each cluster corresponds to an area served by a predicted base station.

4. The method of claim 2, wherein
the training the prediction model based on the accuracy of each cluster comprises:
determining a target cluster to be used to train the prediction model among the clusters using the accuracy of each cluster; and
training the prediction model by applying identification information of the target cluster and movement paths of user terminals belonging to the target cluster to the prediction model.

5. The method of claim 4, wherein
the determining the target cluster comprises:
based on accuracy of a cluster being lower than a specified reference value, determining the cluster as the target cluster among the clusters, and
the training the prediction model comprises:
training the prediction model to predict base stations for serving the movement paths of the user terminals belonging to the target cluster.

6. The method of claim 1, wherein
the prediction model comprises:
layered deep neural networks configured to train a spatiotemporal feature for mobility of a user terminal by receiving the identification information of the clusters and the previous movement paths of the grouped user terminals; and
fully connected layers configured to output a base station list comprising a probability that the user terminal is at each base station from an output of the layered deep neural networks.

7. The method of claim 6, wherein
a layered deep neural network comprises:
an input layer comprising deep neural network cells and hidden layers, wherein, as the identification information of the clusters and the previous movement paths of the grouped user terminals are applied to the input layer, the hidden layers are configured to learn a movement position, to which the user terminal is predicted to move, based on the previous movement paths.

8. The method of claim 6, wherein
the server is configured to:
align the probability that the user terminal is at each base station, output through the fully connected layers, and output the base station list comprising base stations corresponding to a probability as a certain percentage among aligned probabilities.

9. The method of claim 1, wherein
the grouping comprises:
grouping the user terminals into the clusters through a similarity between any one or a combination of a movement time and a movement pattern based on the mobility data,
wherein the movement time comprises:
any one or a combination of a time of a day, a day of a week, a date, and a season.

10. The method of claim 1, wherein
the grouping comprises:
grouping the user terminals into the clusters using a machine learning-based clustering technique comprising a k-mean clustering technique, a k-nearest neighbor clustering technique, and a mean-shift clustering technique.

11. The method of claim 1, wherein
the collecting the mobility data comprises:
collecting the mobility data by sampling the movement paths of the user terminals at fixed time intervals.

12. A method of operating a server, the method comprising:
receiving mobility data of a target terminal;
determining a target cluster to comprise the target terminal, based on the mobility data;
predicting a movement position of the target terminal by inputting identification information of the target cluster and a previous movement path of the target terminal into a trained prediction model; and
providing a service for the target terminal at a predicted movement position.

13. The method of claim 12, wherein
the determining the target cluster comprises:
determining the target cluster to comprise the target terminal by comparing a result of analyzing any one or a combination of a movement time and a movement pattern based on the mobility data with a specified cluster type.

14. The method of claim 12, wherein
the prediction model comprises:
a neural network-based prediction model trained to predict base stations for serving a position to which the target terminal is predicted to move through previous movement paths of user terminals belonging to each cluster and type information of clusters.

15. A server comprising:
a communication interface, comprising communication circuitry, configured to receive mobility data of user terminals; and
at least one processor, comprising processing circuitry, individually and/or collectively, configured to: group the user terminals into clusters based on a similarity of the mobility data and train a prediction model to predict a base station for serving a movement position of the user terminals belonging to each cluster by applying previous movement paths of grouped user terminals to the prediction model based on a neural network.
